(19) United States
(12) Patent Application Publication
(10) Pub. No.: US 2026/0336833 A1
(43) Pub. Date: Oct. 29, 2026

(54) Critical-Inclination Propulsion Schedule - Methods and Systems for Fuel-Free Orbital Inclination Manoeuvres at Phi-Derived Critical Inclinations Using Recognition-Physics Gravity Perturbations

(71) Applicant: Jonathan Washburn, Austin, TX (US)

(72) Inventor: Jonathan Washburn, Austin, TX (US)

(21) Appl. No.: 19/651,732

(22) Filed: Apr. 19, 2026

Related U.S. Application Data
(60) Provisional application No. 63/794,552, filed on Apr. 25, 2025.

(51) Int. Cl. B64G 1/24; B64G 1/28; B64G 1/36; G05D 1/49; G05D 109/40

(52) U.S. Cl. CPC B64G 1/245; B64G 1/242; B64G 1/283; B64G 1/361; G05D 1/49; G05D 2109/40

(57) ABSTRACT

A method, system, and control architecture are disclosed for adjusting spacecraft orbital inclination without consuming propellant during trim phases. A fixed Recognition-Physics critical inclination is defined by i_phi=arccos(1/sqrt(1+k0\hat{ }2)), where k0=pi/phi. A four-phase schedule comprising Charge, Flip, Discharge, and Reset is executed so that a spacecraft assumes a first attitude state in an ascending-node window and a reversed attitude state in a descending-node window. The schedule exploits a sign change in a Recognition-Physics perturbation at i_phi to convert semi-major-axis energy into secular inclination change. The trim phases are executed using only reaction wheels. In preferred embodiments, magnetic torquers provide desaturation for fully zero-propellant operation. Ground-generated or onboard-generated execution windows, together with onboard attitude control and wheel-torque commands, support repeated orbital-cycle execution of the maneuver.

### CROSS-REFERENCE TO RELATED APPLICATIONS

This application claims the benefit of U.S. Provisional Patent Application No. 63/794,552, filed on Apr. 25, 2025, the disclosure of which is incorporated herein by reference in its entirety.

### BACKGROUND OF THE INVENTION

The present invention pertains to satellite orbit control and, more particularly, to propellant-free orbital inclination manoeuvres using a fixed Recognition-Physics gravity scale k0=pi/phi, a derived critical inclination i_phi, and a timed four-phase spacecraft attitude schedule executed using reaction wheels during trim phases, with preferred magnetic-torquer desaturation in fully zero-propellant embodiments.

Inclination control remains one of the most propellant-expensive manoeuvres in spacecraft operations. In low-Earth-orbit constellations, inclination stationkeeping can consume substantial delta-V on a recurring basis, and in geostationary or other long-duration missions, inclination correction can materially deplete the available propellant budget. In many cases, a spacecraft reaches an effective end of life because the propellant allocated to inclination control is exhausted even though other spacecraft subsystems remain functional and capable of continued service. This operational burden makes inclination control a persistent constraint on mission duration, launch mass allocation, and overall spacecraft economics.

Known non-propellant or low-propellant approaches have not provided practical inclination control above drag-dominated regimes. Differential aerodynamic-drag approaches primarily affect semi-major axis rather than producing practical true inclination change. Solar-radiation-pressure approaches are generally too weak to provide useful inclination trimming in many operational contexts. Gravity-gradient torque is principally an attitude-maintenance mechanism rather than a practical orbital inclination-control mechanism. Electromagnetic tether approaches are limited by geometry, environment, and operating regime. As a result, a need remains for a practical technique capable of producing useful orbital inclination change without consuming propellant during the trim phases of the manoeuvre.

The disclosed invention arises from a distinct Recognition-Physics perturbation opportunity. Within the disclosed framework, the gravitational potential modifies the Newtonian potential with a fractional term and gives rise to a secular disturbing-function contribution that depends on orbital inclination. That inclination-dependent behavior vanishes at a specific critical inclination and changes sign across that crossover. This sign-changing behavior creates an opportunity to harvest the perturbation through a deliberately timed spacecraft attitude schedule so that a repeated orbital-cycle sequence produces net inclination trim.

This disclosed critical inclination is not the conventional J2 frozen-perigee critical inclination. It has a different origin, a different value, and a different mechanism. Conventional J2 critical-inclination concepts are associated with freezing or stabilizing one or more orbital elements, such as argument of perigee, under zonal-harmonic effects. By contrast, the presently disclosed mechanism uses a fixed Recognition-Physics critical inclination as a sign-changing crossover and employs a timed four-phase attitude schedule to trade semi-major axis for inclination. Accordingly, the disclosed approach addresses a different physical mechanism and a different operational result from conventional frozen-orbit or J2-based critical-inclination techniques.

In view of the foregoing, there remains a need for methods and systems that can exploit a fixed and parameter-free Recognition-Physics critical inclination together with a timed four-phase attitude schedule to achieve practical orbital inclination trim without consuming propellant during the trim phases, while preserving preferred pathways to fully zero-propellant operation through magnetic desaturation.

### SUMMARY OF THE INVENTION

The invention provides a method and system for changing spacecraft orbital inclination without consuming propellant during trim phases by exploiting a fixed Recognition-Physics critical inclination and a timed four-phase attitude schedule executed using only reaction wheels during the trim phases.

In the disclosed Recognition-Physics framework, a fixed gravity scale is defined by k0=pi/phi, and a corresponding critical inclination is defined by i_phi=arccos(1/sqrt(1+k0\hat{ }2)). The critical inclination is fixed and parameter-free within the disclosed framework. At this critical inclination, the relevant Recognition-Physics perturbation changes sign. That sign-changing crossover is a load-bearing feature of the disclosed propulsion mechanism.

The disclosed invention uses that fixed sign-changing crossover together with a timed four-phase attitude schedule comprising Charge, Flip, Discharge, and Reset. In representative operation, spacecraft 100 is commanded into first attitude state 108 during ascending-node window 102 and into reversed attitude state 110 during descending-node window 120, thereby harvesting the disclosed sign-changing perturbation crossover. By repeating the phased schedule over successive orbital cycles, the spacecraft converts semi-major-axis energy into secular inclination change. The disclosed mechanism therefore trades semi-major axis for inclination rather than freezing an orbital element.

Below i_phi, the Recognition-Physics perturbation tends toward lower inclination. Above i_phi, the Recognition-Physics perturbation tends toward higher inclination. At i_phi, the perturbation is zero. By deliberately applying different spacecraft orientations in different orbital windows relative to that crossover, the disclosed schedule harvests the sign-changing perturbation to produce net inclination trim.

The disclosed invention may be understood as comprising four principal components. A first component is the fixed Recognition-Physics critical inclination architecture, including k0=pi/phi and i_phi=arccos(1/sqrt(1+k0\hat{ }2)). A second component is the four-phase attitude schedule comprising Charge, Flip, Discharge, and Reset. A third component is a guidance and control architecture in which execution windows are generated from orbit-state information and onboard control logic executes commanded attitude states and wheel-torque outputs. A fourth component is a preferred zero-propellant operational posture in which reaction wheels perform the trim-phase manoeuvre and magnetic torquers provide preferred desaturation support for fully zero-propellant embodiments.

In representative embodiments, the Charge phase is executed in an ascending-node window, the Flip phase includes rotation of the spacecraft by pi radians about the velocity vector, the Discharge phase is executed in a descending-node window using a reversed orientation state, and the Reset phase restores the spacecraft for repeated cycle execution. The same hardware can trim inclination in either direction by reversing the relevant phase pairing while preserving the same four-phase architecture.

The disclosed critical inclination is different from the conventional J2 critical inclination. It has a different angle, a different origin, and a different mechanism. The disclosed mechanism is also different from frozen-orbit mechanisms because it uses the Recognition-Physics sign-change crossover and the timed four-phase attitude schedule to trade semi-major axis for inclination. The difference between the disclosed Recognition-Physics critical inclination and the J2 critical inclination is measurable and falsifiable.

In preferred implementations, the trim-phase mechanism uses only reaction wheels. In preferred fully zero-propellant embodiments, wheel desaturation is performed using magnetic torquers. One or more paddles, panels, surfaces, or equivalent structures may be used to modulate effective cross-section or perturbation coupling during the phased schedule. Ground segment 122 may generate execution windows using scheduling flow 400 and TLE or other orbit-state information, and an onboard control subsystem may execute quaternion-based or equivalent attitude control through control loop 500 together with wheel-torque commands to carry out the phased manoeuvre.

Representative benchmark analyses indicate practical inclination-trim performance in disclosed operating regimes, and representative validation pathway 800 may include Monte Carlo validation 802, hardware-in-the-loop testing 804, and in-orbit demonstration 806. Such benchmark, simulation-backed, and validation-related material is provided as representative support and does not constitute a universal guarantee for all spacecraft configurations, orbital regimes, or perturbation environments.

Formalisation may be used to prove core mathematical facts and encode benchmark constants for traceability. In representative implementations, such formal support may include validity of the arccos argument, positivity of the critical inclination, boundedness of the critical inclination, reiteration of k0 from phi, and the parameter-free character of the disclosed relation. Such formal support reinforces the fixed and non-empirical character of the disclosed critical-inclination architecture without implying that all engineering performance, mission-life, or operational outcomes are theorem-level results.

Accordingly, the invention provides a spacecraft inclination-control method, system, and supporting control architecture centered on a fixed Recognition-Physics critical inclination, a sign-changing perturbation crossover, and a timed four-phase attitude schedule that converts semi-major-axis energy into secular inclination change without consuming propellant during the trim phases.

### BRIEF DESCRIPTION OF THE DRAWINGS

FIG. 1 is a high-level system and mechanism view showing a spacecraft 100 in orbit 106 about a central body 104, an ascending-node window 102, a descending-node window 120, first and reversed attitude states 108 and 110, trim or trade directions 112, 114, 116, and 118, a ground segment 122, an uploaded schedule 124, and the semi-major-axis-to-inclination energy trade.

FIG. 2 is a critical-inclination derivation and comparison figure showing an inclination-factor plot 200, a zero crossing 202, a Recognition-Physics critical inclination marker 204, a J2 critical inclination marker 206, a window half-width 208, negative and positive regions 210 and 212, and validation outputs 214, 216, and 218 associated with the disclosed sign-change behavior.

FIG. 3 is an orbital-cycle figure showing an orbit cycle 300 with an ascending node 302, a descending node 304, a Charge window 306, a Flip phase 308, a Discharge window 310, a Reset window 312, first and reversed attitude states 314 and 316, a reversed orientation direction 318, and a velocity-vector-referenced axis 320 for the pi-radian rotation.

FIG. 4 is a ground-segment scheduling figure showing a scheduling flow 400 including orbit-state intake 402, propagation 404, argument-of-latitude computation 406, Charge-window generation 408, Discharge-window generation 410, phase-timing assignment 412, and UTC schedule generation 414.

FIG. 5 is an onboard control-loop figure showing a control loop 500 including attitude sensing 502, attitude-state estimation 504, window checking 506, target-attitude selection 508, phase execution 510, controller operation 512, wheel-torque output 514, actuator feedback 516, and execution telemetry 518.

FIG. 6 is a preferred spacecraft hardware figure showing a spacecraft 600 with a bus 602, a payload or spacecraft subsystem 604, reaction wheels 606, an attitude sensor 608, a processor 610, one or more surface or paddle structures 612, optional gimbal structures 614, supporting subsystems 616, magnetic torquers 618, and an optional micro-impulse thruster 620.

FIG. 7 is an energy-trade and benchmark-performance figure showing an energy-trade plot 700 with semi-major-axis decrease 702, inclination increase 704, representative benchmark rate data 706, comparison traces 708 and 710, operating-region markers 712 and 714, and mission-life-extension logic 716 and 718.

FIG. 8 is a validation-pathway figure showing a validation pathway 800 including Monte Carlo validation 802, hardware-in-the-loop validation 804, in-orbit demonstration planning 806, TLE verification 808, altitude-cost verification 810, acceptance criteria 812, and representative validation outputs 814, 816, and 818.

FIG. 9 is a method flowchart showing a method sequence 900 including orbit-state intake 902, window computation 904, Charge execution 906, Flip execution 908, Discharge execution 910, Reset execution 912, repetition logic 914, logging or telemetry 916, and output or completion logic 918 and 920.

FIG. 10 is a software and control-support figure showing a software architecture 1000 including a TLE-to-UTC window generator 1002, a quaternion-window tracker 1004, a command schedule or control logic store 1006, a non-transitory medium 1008, and execution logging support 1010.

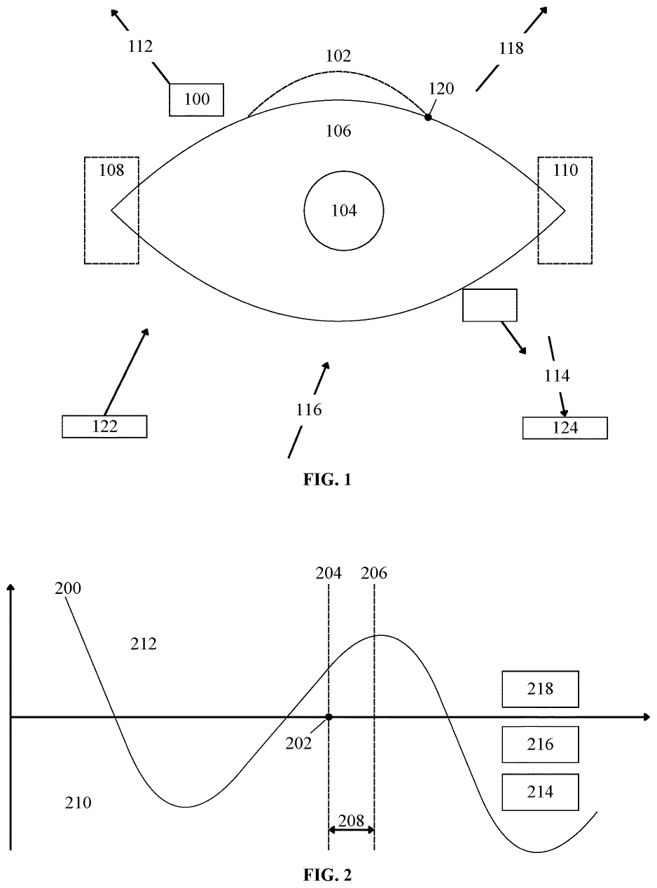

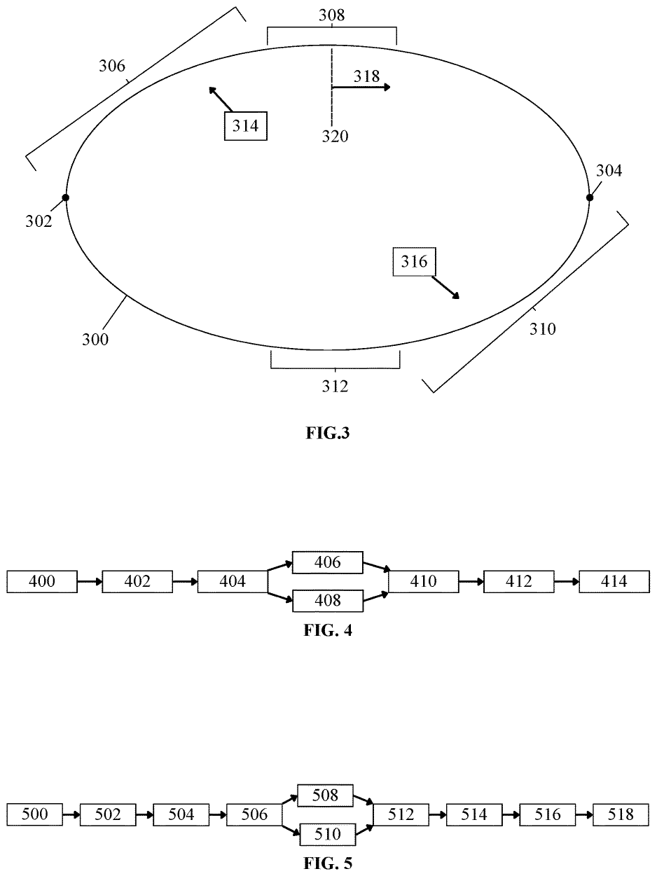

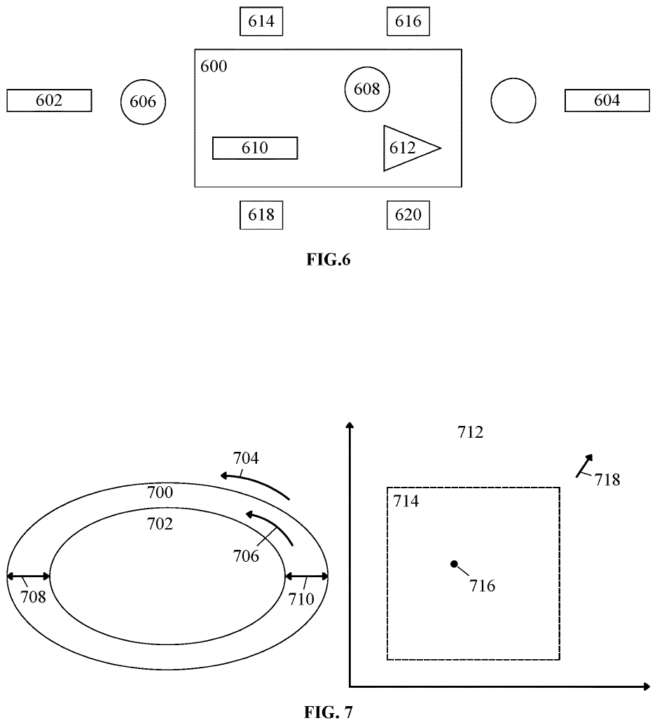

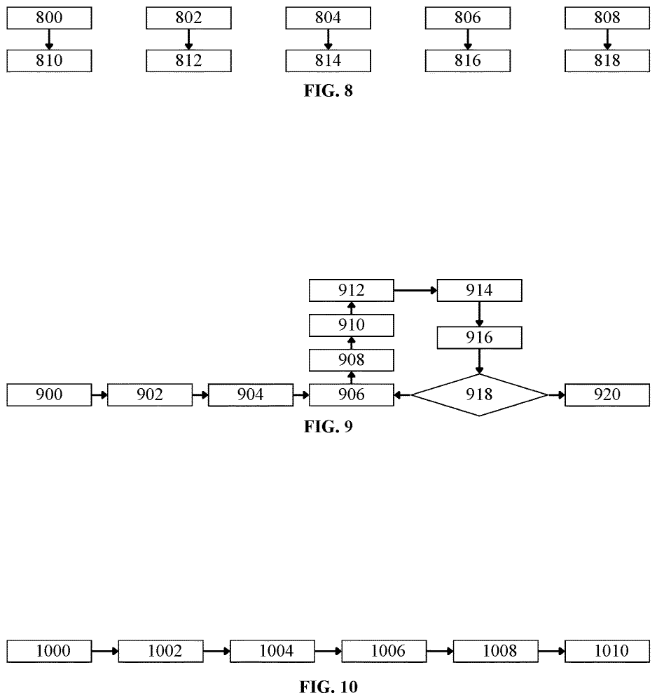

### DETAILED DESCRIPTION OF THE INVENTION

The disclosed invention is not generic attitude control and is not generic orbit control. The disclosed invention uses a fixed Recognition-Physics critical inclination together with a timed four-phase attitude schedule to produce secular inclination change by trading semi-major-axis energy for inclination. The trim-phase mechanism uses only reaction wheels. Magnetic torquers provide a preferred fully zero-propellant desaturation embodiment.

The disclosed inclination-control mechanism is defined by the combined use of a fixed Recognition-Physics critical inclination, at which the Recognition-Physics perturbation changes sign, and a timed four-phase attitude schedule that exploits that sign change to convert semi-major-axis energy into secular inclination change. Preferred hardware implementations, benchmarked performance results, downstream mission applications, and alternative embodiments may further illustrate or implement the disclosed mechanism, but do not alter that mechanism.

The disclosed invention may be understood as comprising four principal components. A first component is a Recognition-Physics critical inclination architecture in which i_phi=arccos(1/sqrt(1+k0\hat{ }2)) and k0=pi/phi, such that the critical inclination is fixed and parameter-free within the disclosed Recognition-Physics framework. A second component is a four-phase attitude schedule comprising Charge, Flip, Discharge, and Reset. A third component is a guidance and control architecture in which execution windows are generated from orbit-state information and onboard attitude execution and wheel-torque control are used to carry out the phased maneuver. A fourth component is a preferred zero-propellant operational posture in which benchmarked performance and representative trade-offs may be achieved while magnetic-torquer desaturation is used in preferred fully zero-propellant embodiments.

A spacecraft 100 is commanded into a first attitude state 108 in an ascending-node window 102 and into a reversed attitude state 110 in a descending-node window 120 so that repetition of the phased schedule over multiple orbits produces a net secular inclination trim without consuming propellant during the trim phases. In this manner, the disclosed mechanism harvests the sign-changing Recognition-Physics perturbation crossover rather than merely stabilizing attitude or freezing a conventional orbital element.

For clarity and consistency, the following symbols and conventions may be used throughout this Detailed Description. Phi may be expressed as phi=(1+sqrt(5))/2. The fixed Recognition-Physics gravity scale may be expressed as k0=pi/phi. The disclosed critical inclination may be expressed as i_phi=arccos(1/sqrt(1+k0\hat{ }2)). A Recognition-Physics scale parameter may be expressed as r 0=2pi/k0=2phi in normalized units. The symbol a may denote semi-major axis. The symbol i may denote orbital inclination. The symbol u may denote argument of latitude measured from the ascending node. The symbol Delta u may denote a window half-width. The symbol delta i may denote inclination change per orbit or per maneuver interval, depending on context. The symbol Delta a may denote the semi-major-axis change associated with the trim.

The four maneuver phases referred to herein are Charge, Flip, Discharge, and Reset. The principal orbital windows referred to herein are ascending-node windows and descending-node windows. Directional trim control may include increasing inclination by one phase ordering and decreasing inclination by reversed phase ordering while preserving the same underlying four-phase architecture.

As used in this specification, “without propellant” means that no propellant is consumed during the trim phases themselves. “Fully zero-propellant embodiment” means an embodiment in which wheel desaturation is performed magnetically rather than with thrusters. “Trim-phase mechanism uses only reaction wheels” means that the Charge, Flip, Discharge, and Reset attitude operations are executed by reaction wheels, even though broader spacecraft momentum-management architecture may, in some embodiments, include optional desaturation hardware.

Implementation terms that may also be used herein include orbit-state input, TLE input, UTC window list, target attitude state, target quaternion, nominal attitude, wheel torque command, desaturation event, execution telemetry, and command schedule. Such implementation terms support practical make-and-use disclosure and control-architecture description, but do not redefine the invention away from the fixed Recognition-Physics critical-inclination sign-change kernel and the timed four-phase schedule.

The disclosed Recognition-Physics perturbation basis may be expressed using a gravitational potential of the form:

V_RP(r)=−GM/r×[1+(r/r0)\hat{ }(5/6)]\hat{ }(−1)

where r is radial distance, G is the gravitational constant, M is central-body mass, and r0 is a Recognition-Physics scale parameter. This potential provides the basis for the inclination-dependent secular behavior exploited by the present propulsion schedule. The present invention is directed to the orbital-control method and system that use that behavior to produce inclination trim, rather than to the broader theory in isolation.

From this Recognition-Physics perturbation basis, a secular disturbing-function contribution includes an inclination-dependent factor that may be written as:

g(i; k0)=(1+k0\hat{ }2)cos\hat{ }2(i)−1

This factor determines the sign behavior used by the disclosed propulsion schedule. In particular, the factor vanishes at a specific critical inclination, and the resulting sign crossover is a load-bearing physical kernel of the disclosed inclination-control mechanism.

The inclination-dependent factor vanishes when:

cos\hat{ }2(i)=1/(1+k0\hat{ }2)

Accordingly, the disclosed Recognition-Physics critical inclination is:

i_phi=arccos(1/sqrt(1+k0\hat{ }2))

Within the disclosed Recognition-Physics framework, k0=pi/phi. In representative numeric terms, k0 is about 1.941, and the resulting critical inclination i_phi is about 62.74 degrees. Within that framework, k0=pi/phi is fixed and parameter-free. The disclosed critical inclination i_phi is therefore fixed and fully determined within that framework. The disclosed critical inclination is not presented as empirically tuned and is not presented as one selected option from a family of interchangeable alternatives.

The propulsion schedule is keyed to a mathematically defined and sign-changing Recognition-Physics crossover point rather than to a merely convenient orbital inclination. That crossover point is central to the identity of the disclosed invention because the operational maneuver depends on the fixed perturbation sign change at i_phi.

Formal mathematical support may be used to reinforce the integrity of this critical-inclination architecture. In representative implementations, such support may include validation of the arccos argument, positivity of the critical inclination, boundedness of the critical inclination, reiteration of k0 from phi, and the parameter-free character of the disclosed relation. Such formal support reinforces the fixed and non-empirical character of the disclosed Recognition-Physics critical inclination without implying that all benchmarked performance, mission-use outcomes, or engineering implementations are themselves theorem-level results.

The disclosed Recognition-Physics critical inclination may be compared to conventional critical-inclination concepts including the J2 critical inclination, Molniya or frozen-perigee critical inclinations, and other critical-inclination formulations used to freeze or stabilize one or more orbital elements. The disclosed Recognition-Physics critical inclination has a different angle, a different origin, and a different mechanism from the J2 critical inclination. It is close to, but distinct from, the J2 critical inclination, and that distinction is measurable and falsifiable.

In representative terms, the J2 critical inclination is about 63.43 degrees, whereas the disclosed Recognition-Physics critical inclination is about 62.74 degrees, yielding an angular separation of about 0.69 degrees. This numerical proximity does not imply identity. To the contrary, the disclosed Recognition-Physics critical inclination arises from the fixed relation k0=pi/phi and the resulting sign-changing Recognition-Physics inclination factor, whereas the J2 critical inclination arises from zonal-harmonic orbital mechanics associated with frozen-perigee behavior.

Functionally, J2 frozen-orbit mechanisms are used to freeze orbital elements such as argument of perigee. The disclosed Recognition-Physics schedule instead trades semi-major axis for inclination through phased attitude control around the Recognition-Physics sign crossover. The disclosed mechanism is therefore different in origin, different in operation, and different in result from conventional frozen-orbit or J2 critical-inclination techniques.

Below i_phi, the Recognition-Physics perturbation tends toward lower inclination. Above i_phi, the Recognition-Physics perturbation tends toward higher inclination. At i_phi, the Recognition-Physics perturbation is zero. This sign behavior is operationally important because it provides the crossover that is harvested by the disclosed four-phase schedule.

By changing spacecraft orientation across ascending-node and descending-node windows, the sign behavior is harvested rather than canceled. One phase couples the spacecraft into the perturbation with a first effective orientation. Another phase couples the spacecraft into the perturbation with a reversed effective orientation. The resulting asymmetry over the orbital cycle produces secular inclination trim rather than merely oscillatory disturbance.

The disclosed mechanism trades semi-major axis for inclination and is therefore an orbital energy-transfer technique implemented through a timed attitude schedule that exploits a sign-changing Recognition-Physics perturbation, rather than a frozen-orbit mechanism or a mere attitude-stabilization mechanism.

In representative implementations, the spacecraft may be placed into a cross-section or coupling orientation configured to maximize effective Recognition-Physics perturbation coupling during one orbital window and into a reversed orientation state configured for opposite-sign interaction during the corresponding opposite window. Such orientation states remain tied to the disclosed phased schedule and Recognition-Physics perturbation sign behavior, rather than to generic interaction optimization.

The invention should be understood as the combined use of the fixed Recognition-Physics sign-change crossover with the timed four-phase attitude schedule. The causal chain may be summarized as follows: a fixed Recognition-Physics critical inclination defines a sign-changing perturbation crossover; first attitude state 108 is applied in ascending-node window 102; reversed attitude state 110 is applied in descending-node window 120; the four-phase schedule is repeated over successive orbital cycles; and the repeated schedule converts semi-major-axis energy into secular inclination change.

The disclosed maneuver is a repeating four-phase schedule comprising Charge, Flip, Discharge, and Reset. The schedule is timed relative to orbital position and is repeated over multiple orbits so that a small per-cycle effect accumulates into a secular inclination change. The schedule is not arbitrary sequencing. It is the operational mechanism by which the fixed Recognition-Physics sign-change crossover is harvested for inclination trim.

Inputs to the Charge phase may include current time, current argument of latitude u, target trim direction, current attitude state, current command schedule, and current wheel state. The Charge phase is entered when the spacecraft is within the ascending-node window, which in representative implementations may satisfy:

|u|<=Delta u

During the Charge phase, the spacecraft is commanded into a first attitude state configured to maximize Recognition-Physics perturbation coupling or maximize effective cross-section in the relevant coupling direction. In representative embodiments, one or more paddles, panels, or equivalent surface structures may be oriented face-on or otherwise configured for maximum effective cross-section, while reaction wheels maintain the commanded state. The output of the Charge phase is an increased orbit-inclination coupling state and completion of the first energy-loading portion of the cycle.

The Flip phase is entered at the end of the Charge window or at a commanded phase boundary following Charge. During the Flip phase, the spacecraft is rotated by pi radians about the velocity vector. This rotation reverses the effective cross-section or coupling orientation relative to the Recognition-Physics perturbation field and prepares the spacecraft for the opposite-sign interaction used in the Discharge phase. In representative embodiments, the Flip phase is executed by reaction wheels and may be completed in less than about 60 seconds. This timing is a preferred engineering target that supports practical repeated orbital execution, but remains non-mandatory. The output of the Flip phase is a reversed orientation state for use in the Discharge phase.

Inputs to the Discharge phase may include current time, current argument of latitude u, reversed attitude command, current wheel state, and current command schedule. The Discharge phase is entered when the spacecraft is within the descending-node window, which in representative implementations may satisfy:

|u−pi|<=Delta u

During the Discharge phase, the spacecraft maintains the reversed orientation in the descending-node window. In this phase, the Recognition-Physics perturbation acts in the opposite direction, such that semi-major-axis energy is extracted and deposited as inclination change. The output of the Discharge phase is completion of the energy-transfer portion of the cycle and a net secular inclination contribution.

The Reset phase follows the Discharge phase and restores the spacecraft toward the initial orientation for the next cycle. The Reset phase may occur after the Discharge window or at a commanded phase boundary following Discharge. During the Reset phase, the spacecraft is rotated back toward the initial state and returned to a condition suitable for repeated orbital-cycle execution. In some implementations, the Reset phase may also provide an opportunity for wheel-momentum reduction or for scheduling a desaturation sequence outside active trim windows. The output of the Reset phase is cycle reset and readiness for repetition.

A representative relation for the per-orbit inclination effect may be written as:

delta i=C×(r0/a)\hat{ }(5/6)×sin(2i)×Delta u

where C is a representative dimensionless constant from Recognition-Physics potential analysis, with C being about 2.3×10\hat{ }−6 in one representative low-Earth-orbit analysis, r0/a captures scaling dependence, sin(2i) captures inclination dependence, and Delta u captures window-width dependence. This relation is useful as a quantitative implementation anchor because it expresses how the phased schedule, orbital scale, and inclination state cooperate to produce the disclosed trim effect.

In a representative benchmark case at about 700 km altitude and near the disclosed critical-inclination regime, representative values may include about 0.014 degrees per orbit, about 0.2 degrees per day, and about 3 degrees in about 15 days. These values are representative benchmark anchors and not universal guarantees. They are provided to illustrate practical operation in disclosed example regimes and should not be read as mandatory performance limits or universally achieved results across all spacecraft configurations, orbital environments, or perturbation conditions.

The same hardware may be used to trim inclination in either direction. To increase inclination, the schedule may be executed in the phase ordering described above. To decrease inclination, Charge and Discharge pairing may be reversed while preserving the same underlying four-phase architecture. This bidirectionality is significant because it shows that the disclosed mechanism is a reversible trim architecture rather than a one-direction-only maneuver.

The four-phase schedule may be repeated for a selected number of orbits, repeated until a target inclination change is achieved, repeated until a mission-defined stopping condition is reached, or paused or suspended based on desaturation needs, safety rules, or mission priorities. Stopping conditions may therefore be selected according to mission objectives without altering the underlying Recognition-Physics sign-change kernel or four-phase maneuver structure.

The disclosed guidance and control architecture may be divided into a ground segment and an onboard segment. This division is a preferred implementation architecture and also provides concrete support for system and non-transitory-medium claim positions because it ties orbit-state processing to real onboard maneuver execution.

Inputs to the ground segment may include current TLE or equivalent orbit-state data, target trim direction, Delta u, mission constraints, exclusion windows, and safety constraints. The ground segment 122 may ingest orbit-state input 402, propagate the orbit at 404, compute u(t) at 406, compute Charge windows at 408, compute Discharge windows at 410, assign phase timing at 412, generate a UTC window list at 414, and prepare a command schedule for uplink. Outputs of the ground segment may include a Charge window list, a Discharge window list, a phase schedule, target command packets, and an execution schedule.

The onboard segment may receive current time, current quaternion or equivalent attitude state, an uploaded window list, a nominal attitude state, actuator state information, and wheel-state information. The onboard segment may read attitude-sensor output 502, perform attitude-state estimation 504, perform window checking 506, select a target attitude or quaternion at 508, execute phase control 510, compute wheel torque through a controller at 512, and output wheel-torque commands at 514 for execution, with actuator feedback 516 and execution telemetry 518. A representative control logic corresponding to control loop 500 may therefore be expressed as follows. If current time is inside a Charge window, the onboard segment executes the Charge target attitude. Else if current time is inside a Discharge window, the onboard segment executes the Discharge target attitude. Otherwise, the onboard segment executes a nominal attitude. If a commanded phase boundary is reached, the onboard segment executes Flip or Reset according to the schedule. If wheel-momentum accumulation exceeds an operational threshold or limit, the system may invoke desaturation outside critical windows or during scheduled maintenance periods. Specific threshold values may be selected according to spacecraft design and mission needs and need not be fixed in the broadest embodiments.

Preferred sensing and control implementations may include a blind-spot sensor providing about 0.3 arcsecond attitude determination, a 10 Hz quaternion-control loop, a 200 Hz wheel-torque command rate, and a GR740-class or equivalent processor architecture operating at representative CPU utilization of about 35 percent in one preferred implementation. Optional implementations may include a star tracker in place of, or in addition to, the blind-spot sensor, along with additional state-estimation refinements such as Kalman fusion, MEMS gyro integration, or equivalent attitude-estimation refinements in narrower embodiments. Such implementation details are useful fallback anchors and enablement support, but do not narrow the broadest method concept.

The control architecture may generate, store, or output a UTC window schedule from 1002, target attitude commands and quaternion setpoints from 1004 and 1006, wheel-torque commands at 514, execution telemetry 518, desaturation flags, post-maneuver orbit estimates, and a command schedule used to execute the phased maneuver. These outputs are implementation products of the disclosed propulsion mechanism and should be understood as subordinate to, and supportive of, the fixed Recognition-Physics critical-inclination sign-change kernel and the timed four-phase maneuver.

The trim-phase maneuver uses only reaction wheels, and no propellant is consumed during the Charge, Flip, Discharge, and Reset trim phases. This trim-phase propulsion posture should be understood separately from the broader spacecraft momentum-management architecture.

In a preferred fully zero-propellant embodiment, magnetic torquers 618 are used to dump wheel momentum into the planetary magnetic field. This provides a fully zero-propellant operational embodiment, including momentum management as well as trim-phase execution. In representative implementations, desaturation may occur over one or more orbits, including over about one to two orbits in one representative embodiment, and may be scheduled outside active trim windows so that the trim-phase maneuver remains uninterrupted by desaturation events.

In an optional embodiment, a micro-impulse thruster may be used for wheel desaturation. This optional embodiment does not alter the fact that the trim-phase schedule itself remains propellant-free. In one representative embodiment, desaturation impulse may be about 0.2 mN-s per week and annual propellant consumption may be less than about 0.1 g per year. Such values are representative and non-limiting engineering examples rather than requirements of the invention.

Accordingly, the disclosed invention distinguishes between the trim-phase maneuver, which uses only reaction wheels and does not consume propellant, and the broader momentum-management architecture, which may in preferred embodiments remain fully zero-propellant through magnetic desaturation or may in optional embodiments use limited propellant for desaturation. This distinction preserves broad method coverage while also preserving narrower fully zero-propellant fallback coverage.

A strong narrower fallback package may therefore include reaction wheels for Charge, Flip, Discharge, and Reset, magnetic torquers for wheel desaturation, one or more cross-section-modulating surfaces or paddles used during the phased maneuver, no propulsion system for trim execution, and a fully zero-propellant operational posture. Magnetic torquers are preferred but need not be required in the broadest method articulation, and micro-thruster desaturation remains an optional dependent or narrower embodiment.

The disclosed propulsion schedule may be implemented on a spacecraft 600 including a bus 602, a payload or spacecraft subsystem 604, a reaction wheel assembly 606, one or more surface or paddle structures 612 configured to modulate effective cross-section or perturbation coupling, optional gimbal assemblies 614, an attitude sensor suite 608, a processor or flight computer 610, magnetic torquers 618, optional micro-thrusters 620, and supporting subsystems 616. This hardware architecture is a concrete implementation pathway for the disclosed control method rather than a redefinition of the invention around hardware detail.

Reaction wheels provide the trim-phase attitude actuation. In representative implementations, the reaction wheels execute Charge, Flip, Discharge, and Reset, store and release angular momentum during the phased maneuver, and constitute the trim-phase actuator core of the disclosed system. Representative torque and speed values may be disclosed as preferred engineering examples, including reaction-wheel torque capacity of about 0.2 N-m and representative wheel-speed capacity of about 6000 rpm sufficient to execute the phased maneuver over repeated orbital cycles. Such values remain preferred and non-limiting, but provide useful enablement and apparatus fallback support.

One or more spacecraft surfaces, paddles, panels, appendages, or equivalent structures may be oriented to modulate effective cross-section or perturbation coupling. The attitude schedule may be implemented using such structures to create the differential coupling state between the Charge phase and the Discharge phase. Where paddles are used, gimbal structures may provide a preferred implementation, including representative paddle area of at least about 1 m\hat{ }2 per side and representative gimbal range of about +/−180 degrees in one preferred embodiment. These structures remain tied to orientation-based perturbation coupling and should not be generalized into unrelated aerodynamic, electrodynamic, or generic interaction-optimization architectures. Preferred and optional sensor implementations may include a preferred blind-spot sensor embodiment, an optional star-tracker embodiment, and optional additional inertial-sensor support such as MEMS gyros in narrower embodiments. Representative attitude-determination accuracy values may be disclosed as preferred engineering support and fallback material, but such values remain implementation detail rather than core limitations.

Processor 610 or a flight computer may execute onboard phase logic, receive or store the window schedule, select target attitudes or quaternions, compute or output wheel-torque commands, and execute telemetry, logging, and validation-support functions. A GR740-class processor or equivalent may be used as a preferred implementation, although processor class remains a preferred engineering embodiment rather than a mandatory limitation.

Desaturation hardware may include magnetic torquers as the preferred fully zero-propellant desaturation mechanism and optional micro-thrusters as a non-zero-propellant desaturation alternative. This hardware supports long-duration repeated schedule execution while preserving the distinction between trim-phase actuation and broader momentum-management architecture. Power requirements, mass impact, and environmental or thermal operating considerations may be disclosed in representative and non-limiting form. Representative engineering values, including mass impact of about 2.6 kg, power draw of about 8 W, and operating temperature capability below about −40 degrees C in one representative embodiment, are useful for enablement, preferred embodiments, and practical buildability. Such values should not migrate into the core invention statement or the broadest independent claim posture.

A preferred narrower hardware package may therefore include bus 602, reaction wheels 606 for trim-phase execution, one or more cross-section-modulating surfaces or paddles 612, onboard processor 610 executing the phased schedule, attitude sensor 608 with representative arcsecond-class accuracy, and magnetic torquers 618 for desaturation. This package provides a concrete apparatus fallback with strong commercial and prosecution value while remaining subordinate to the core propulsion mechanism.

The disclosed method and system may use operative inputs including TLE or equivalent orbit-state input, current spacecraft attitude quaternion or equivalent attitude state, current time, window half-width Delta u, target trim direction, nominal attitude state, actuator status, wheel-momentum state, mission constraints, and exclusion windows or safety constraints. These inputs are real operational inputs supporting make-and-use disclosure, rather than abstract information categories divorced from spacecraft execution.

The disclosed method and system may generate outputs including a UTC window schedule, target attitude commands, quaternion setpoints, wheel-torque commands, phase-transition commands, desaturation commands or flags, execution telemetry, and a post-maneuver orbit estimate. These outputs support schedule execution and maneuver performance and should not be understood as redefining the invention as a generic data-product or software-record system. Useful subordinate implementation products may include a TLE-to-UTC window generator 1002, a quaternion-window tracker 1004, a command schedule or control logic store 1006 used to execute the four-phase maneuver, and a non-transitory computer-readable medium 1008 with execution logging support 1010. These items support system, medium, and software-adjacent claim positions, but remain subordinate to the orbital-control method core and should not be described in a manner that causes the application to read primarily as a software case.

The disclosed rates, trade-offs, and mission-life consequences discussed herein are benchmark or representative analysis results and are not universal guarantees for all spacecraft configurations, orbital regimes, or perturbation environments. This benchmark posture should remain express because it preserves useful quantitative support without overstating the scope of demonstrated performance.

Representative altitude-versus-rate analysis associated with energy-trade plot 700 may include representative rate data 706, comparison traces 708 and 710, operating-region markers 712 and 714, representative delta i per day values, representative time-to-target-trim values, and the observed reduction in trim effect with increasing altitude. Such analysis is useful because it identifies practical operating regimes and supports narrower mission-class claims and examples. In representative embodiments, the disclosed operating band may include altitudes of about 500 km to about 800 km, with a representative benchmark case at about 700 km.

As reflected in representative benchmark rate data 706 of FIG. 7, benchmark values may include about 0.014 degrees per orbit, about 0.2 degrees per day, and about 3 degrees in about 15 days for a representative 700 km benchmark case. These values are useful quantitative anchors and fallback support, but the invention is not defined by any single rate, altitude, mission-life percentage, or business metric.

A representative relation for semi-major-axis cost may be stated as:

Delta a about −a×(delta i/57.3)×tan(i_phi)×(r0/a)\hat{ }(1/6)

This relation reflects the energy trade shown in FIG. 7, including semi-major-axis decrease 702 and inclination increase 704, and confirms that altitude or semi-major-axis reduction is part of the disclosed mechanism rather than an incidental side effect. In a representative benchmark case involving about 3 degrees of inclination change at about 700 km altitude, the associated semi-major-axis reduction may be about 680 m. This value is representative and non-limiting, but it usefully illustrates that the semi-major-axis cost may be small relative to the practical value of the resulting inclination trim.

Representative and subordinate benefit discussion may include elimination or reduction of inclination-propellant budget, mission-life extension, launch-mass or operational-mass reallocation, and cost or revenue benefits in representative use cases. Such benefits are downstream or representative consequences of the disclosed mechanism and should not be presented as the core inventive mechanism itself.

Formal verification and traceability may also be used to support the disclosed critical-inclination architecture. In representative implementations, relevant formalization may be associated with a RecognitionCriticalInclination.lean module or equivalent formal-verification material. Specific proved items that may be preserved include arccos_arg_valid, critical_inclination_positive, critical_inclination_bounded, k0_from_phi_reiterate, and parameter_free. These items support the mathematical integrity of the disclosed critical-inclination architecture and should be distinguished from benchmark, implementation, or mission-use material.

Encoded traceability constants may also be preserved separately from theorem-level material. Representative encoded constants may include propellant_per_cycle_kg=0, trim_time_days=15, inclination_rate_day=0.2, attitude_error_arcsec=0.3, mass_kg=2.6, and life_extension_pct=18. These values are useful because they tie formalized support to representative engineering or benchmark embodiments, but they should not be collapsed into theorem-level proof language.

The specification should preserve express distinctions among theorem-level material, encoded traceability constants, benchmark analysis, simulation-backed examples, and future validation targets. Formal verification belongs in the specification body as support and credibility reinforcement, and the claims should not overstate formal proof of engineering performance or mission outcomes.

Brief cross-reference may also be made to related Recognition-Physics patent materials. Upstream support may include Gravity Kernel Solver, Physical Constants Derivation, and Renormalisation Engine as sources for the Recognition-Physics gravitational framework and the derivation of k0. Companion navigation and sensing support may include blind-spot sensor, autonomous navigation, or related attitude-determination tools where relevant. Such cross-referential material should remain brief and subordinate so that the present application retains its identity as a propulsion-schedule and inclination-control case rather than a broad family omnibus.

In an alternative embodiment, the same or related schedule logic may be adapted to transfer semi-major-axis energy into eccentricity rather than inclination. In another alternative embodiment, timing or phase relationships may be adapted to target right ascension of ascending node rather than inclination. In a further alternative embodiment, a multi-objective schedule may be used to affect both inclination and right ascension of ascending node. These embodiments are expressly alternative and do not redefine the core invention, which is centered on inclination control using the fixed Recognition-Physics critical inclination and the timed four-phase schedule.

In another alternative embodiment, the Recognition-Physics attitude schedule may provide coarse trim while electric propulsion provides fine trim. In still other embodiments, synchronized execution across multiple spacecraft may provide relative-control benefits, or a modified schedule may be used to drive orbit changes relevant to de-orbit or decay acceleration. Such subject matter may be useful for broader family strategy, future continuation practice, or narrower embodiments, but remains subordinate to the present core inclination-control invention. Representative downstream mission-use embodiments may include low-Earth-orbit constellation maintenance, geostationary end-of-life inclination management, CubeSat no-propulsion control, Mars relay orbit trim, and sun-synchronous recovery. In a representative low-Earth-orbit constellation embodiment, repeated execution of the disclosed schedule may maintain inclination across multiple spacecraft while reducing or eliminating inclination-propellant expenditure. In a representative geostationary embodiment, the schedule may continue to provide useful inclination management after traditional inclination-control propellant is exhausted. In a representative CubeSat embodiment, a spacecraft lacking a propulsion system may use reaction wheels for trim-phase execution and magnetic torquers for desaturation. In a representative Mars relay embodiment, the disclosed phased schedule may counter inclination drift in a planetary-orbiter mission profile. In a representative sun-synchronous recovery embodiment, the disclosed schedule may correct an off-target launch inclination toward a desired sun-synchronous value. These mission scenarios are illustrative applications of the core mechanism and are not the invention's central identity.

The following examples are illustrative and are provided to support understanding, enablement, and practical implementation of the disclosed inclination-control technique. Unless expressly stated otherwise, the examples are representative scenario analyses, benchmark analyses, or simulation-backed examples, and should not be read as universal guarantees or as implying completed in-orbit reduction to practice.

In a representative Example A involving low-Earth-orbit constellation stationkeeping, a multi-satellite constellation may operate at a representative altitude and target inclination while maintaining inclination within a defined band. Conventional operation may consume substantial propellant for stationkeeping, whereas repeated execution of the disclosed Recognition-Physics schedule may provide continued trim support with reduced or eliminated inclination-propellant expenditure. This is a representative scenario analysis and a downstream embodiment, not the core invention.

In a representative Example B involving geostationary end-of-life inclination control, a satellite approaching depletion of its conventional inclination-control propellant may use the disclosed four-phase schedule to continue providing useful inclination management. Resulting life-extension or revenue effects, where discussed, are downstream consequences rather than the inventive kernel itself.

In a representative Example C involving a CubeSat embodiment, a compact spacecraft may employ reaction wheels, one or more cross-section-modulating structures, a sensor package, and magnetic torquers over a representative execution duration such as about ninety days. A target inclination change may be evaluated in simulation, and a representative Orekit or equivalent result may be described as simulation-backed. This example is valuable for enablement and fallback support, but it should be expressly understood as simulation-backed rather than flight-demonstrated unless later support establishes otherwise.

In a representative Example D involving Mars relay orbit trim, the phased schedule may be used in an elliptical relay-orbit context to counter inclination drift and preserve useful mission geometry. In a representative Example E involving sun-synchronous recovery, the phased schedule may be used to correct an off-target launch inclination toward a desired sun-synchronous target. In a representative Example F involving a fully propellant-free CubeSat, reaction wheels may provide trim-phase execution and magnetic torquers may provide desaturation in a spacecraft with no propulsion system. These examples are downstream embodiments or strong fallback packages and should remain subordinate to the core mechanism. Validation pathways 800 may include Monte Carlo validation 802 including relevant perturbation factors, hardware-in-the-loop or air-bearing-table validation 804, an in-orbit demonstration target 806, TLE verification 808, and altitude-cost verification 810. Representative validation metrics may include an RMS inclination-error target of less than or equal to about 0.02 degrees after about 90 cycles, a window-tracking-error target of less than or equal to about 0.05 degrees, a measured delta i target of greater than or equal to about 0.4 degrees over about 90 days for an in-orbit demonstration embodiment, a TLE agreement target within about +/−0.05 degrees, and a Delta a agreement target within about +/−100 m. Such validation material is useful and should be preserved, but it remains validation-pathway support unless and until separately demonstrated.

Support levels should remain carefully separated throughout this specification. Theorem-level formal support, encoded traceability constants, benchmark analysis, simulation-backed examples, future validation targets, downstream mission embodiments, alternative embodiments, and continuation-worthy future subject matter are distinct categories. Benchmark analysis is not the same as flight demonstration, simulation-backed examples are not the same as in-orbit reduction to practice, and future validation targets are not the same as completed validation. Maintaining these distinctions preserves both accuracy and claim integrity.

Equivalent orbital propagators may be used in place of a TLE-specific propagator, provided that the disclosed phased schedule and orbital-window logic are maintained. Equivalent surface configurations may also be used so long as the disclosed phased schedule and disclosed sign-change exploitation are maintained. As used in this specification, “without propellant” means no propellant is consumed during the trim phases, magnetic-torquer desaturation defines a preferred fully zero-propellant embodiment, and optional thruster-based desaturation does not alter the trim-phase propellant-free character of the disclosed schedule. Benchmark values are representative and non-limiting unless explicitly claimed in narrower fallback claims. Downstream examples are illustrative applications of the core mechanism and do not redefine the core inclination-control invention. Alternative embodiments remain subordinate to the fixed Recognition-Physics critical-inclination sign-change kernel plus the four-phase schedule. The Detailed Description accordingly preserves the fixed and parameter-free Recognition-Physics critical-inclination architecture, the exact four-phase schedule and its ordering, representative quantitative benchmark and semi-major-axis cost relations, formal-verification and traceability structure, and concrete implementation detail sufficient for make-and-use disclosure, while maintaining explicit separation among core mechanism, preferred embodiments, alternative embodiments, downstream uses, benchmarked material, simulation-backed material, and future validation targets.

1. A method for adjusting orbital inclination of a spacecraft without consuming propellant during trim phases, the method comprising: computing or retrieving a fixed Recognition-Physics critical inclination defined by i_phi=arccos(1/sqrt(1+k0\hat{ }2)), where k0=pi/phi; computing an argument of latitude u(t) from orbit-state information and determining (i) an ascending-node window satisfying |u(t)|<=Delta u and (ii) a descending-node window satisfying |u(t)−pi|<=Delta u; during the ascending-node window, commanding the spacecraft into a first attitude state; after the ascending-node window, rotating the spacecraft by pi radians about a velocity-vector-referenced axis to place the spacecraft into a reversed attitude state; during the descending-node window, maintaining the reversed attitude state; and thereafter resetting the spacecraft toward the first attitude state and repeating a four-phase schedule comprising Charge, Flip, Discharge, and Reset over multiple orbital cycles, wherein the four-phase schedule exploits a sign change in a Recognition-Physics perturbation at i_phi to convert semi-major-axis energy into secular inclination change, and wherein the Charge, Flip, Discharge, and Reset phases are executed using only reaction wheels.

2. The method of claim 1, wherein k0 =pi/phi is fixed and parameter-free within the disclosed Recognition-Physics framework.

3. The method of claim 1, wherein the ascending-node window is defined by |u|<=Delta u, where u is argument of latitude measured from an ascending node.

4. The method of claim 3, wherein the descending-node window is defined by |u−pi|<=Delta u.

5. The method of claim 1, wherein the first attitude state is configured to maximize effective perturbation coupling or effective cross-section during the ascending-node window.

6. The method of claim 1, wherein the sign change corresponds to a zero crossing of g(i;k0)=(1+k0\hat{ }2)cos\hat{ }2(i)−1 at i_phi.

7. The method of claim 1, wherein the same spacecraft hardware is used to increase inclination or decrease inclination by reversing Charge and Discharge pairing while preserving the four-phase schedule.

8. The method of claim 1, further comprising measuring a post-maneuver inclination from updated orbit-state information and terminating repetition of the four-phase schedule when the measured inclination meets a target within a predetermined tolerance.

9. The method of claim 1, further comprising generating, from orbit-state information comprising a TLE input, a schedule identifying times for the ascending-node window and the descending-node window.

10. The method of claim 1, wherein no propellant is consumed during the Charge, Flip, Discharge, and Reset phases.

11. A spacecraft system for adjusting orbital inclination without consuming propellant during trim phases, the system comprising: a reaction wheel assembly configured to execute a four-phase attitude schedule comprising Charge, Flip, Discharge, and Reset; a control subsystem configured to compute an argument of latitude u(t) from orbit-state information and determine (i) an ascending-node window satisfying |u(t)|<=Delta u and (ii) a descending-node window satisfying |u(t)−pi|<=Delta u, command a first attitude state during the ascending-node window, command a reversed attitude state during the descending-node window, and command a pi-radian rotation about a velocity-vector-referenced axis between the first attitude state and the reversed attitude state; and a processor configured to execute control logic based on a fixed Recognition-Physics critical inclination defined by i_phi=arccos(1/sqrt(1+k0\hat{ }2)), where k0=pi/phi, wherein the control subsystem is configured to repeat the four-phase attitude schedule over multiple orbital cycles so that a sign change in a Recognition-Physics perturbation at i_phi converts semi-major-axis energy into secular inclination change.

12. The system of claim 11, further comprising one or more surfaces, paddles, panels, or appendages configured to modulate effective cross-section or perturbation coupling between the first attitude state and the reversed attitude state.

13. The system of claim 11, further comprising a magnetic-torquer subsystem configured to desaturate the reaction wheel assembly without propellant.

14. The system of claim 11, further comprising an attitude sensor configured to provide attitude information to the control subsystem for execution of the four-phase attitude schedule.

15. The system of claim 14, wherein the attitude sensor comprises a blind-spot sensor or a star tracker.

16. The system of claim 11, wherein the control subsystem is further configured to measure a post-maneuver inclination from updated orbit-state information and terminate repetition of the four-phase attitude schedule when the measured inclination meets a target within a predetermined tolerance.

17. The system of claim 11, wherein the sign change corresponds to a zero crossing of g(i;k0)=(1+k0\hat{ }2)cos\hat{ }2(i)−1 at i_phi.

18. A non-transitory computer-readable medium storing instructions that, when executed by one or more processors of a spacecraft control system, cause the spacecraft control system to:
compute an argument of latitude u(t) from orbit-state information and determine (i) an ascending-node window satisfying |u(t)|<=Delta u and (ii) a descending-node window satisfying |u(t)−pi|<=Delta u; command a first attitude state during the ascending-node window; command a pi-radian rotation about a velocity-vector-referenced axis to place the spacecraft in a reversed attitude state; command the reversed attitude state during the descending-node window; command a reset toward the first attitude state; and repeat a four-phase schedule comprising Charge, Flip, Discharge, and Reset over multiple orbital cycles based on a fixed Recognition-Physics critical inclination defined by i_phi=arccos(1/sqrt(1+k0\hat{ }2)), where k0=pi/phi, wherein execution of the instructions causes the control system to exploit a sign change in a Recognition-Physics perturbation at i_phi to convert semi-major-axis energy into secular inclination change without consuming propellant during trim phases.

19. The non-transitory computer-readable medium of claim 18, wherein the instructions further cause the spacecraft control system to measure a post-maneuver inclination from updated orbit-state information and terminate repetition of the four-phase schedule when the measured inclination meets a target within a predetermined tolerance.

20. The non-transitory computer-readable medium of claim 18, wherein the sign change corresponds to a zero crossing of g(i;k0)=(1+k0\hat{ }2)cos\hat{ }2(i)−1 at i_phi.
